(19) United States
(12) Patent Application Publication
(10) Pub. No.: US 2013/0124255 A1
(43) Pub. Date: May 16, 2013

(54) Presort Scheme Optimizer and Simulator

(71) Applicants: Celeste Patterson, Parkland, FL (US); Harish C. Sundaram, Weston, FL (US)

(72) Inventors: Celeste Patterson, Parkland, FL (US); Harish C. Sundaram, Weston, FL (US)

(73) Assignee: American Express Travel Related Services Company, Inc., New York, NY (US)

(21) Appl. No.: 13/294,595

(22) Filed: Nov. 11, 2011

(51) Int. Cl. G06Q 10/04

(52) U.S. Cl. 705/7.27

(57) ABSTRACT

A system and method configured for determining optimal mail sorting of a mailing is disclosed. The method may comprise determining a number of mail pieces to be sent in the mailing, selecting an initial scheme for sorting the mailing based on the number of mail pieces, and simulating a mail sorting based on the initial scheme and obtaining efficiency statistics of the simulated mail sorting. After the selected initial scheme is simulated, the method may further comprise generating an updated scheme, in response to the efficiency statistics being less than optimal, by revising the initial scheme. The method includes simulating a mail sorting based on the updated scheme, revising and simulating schemes until efficiency statistics are optimal. The initial scheme may be based on historical schemes for mailings of similar number of mail pieces, selected by an operator from historical schemes for mailings, or a customized scheme for the mailing.

### BACKGROUND ART

Numerous businesses and other organizations mail large quantities of mail, such as bills, statements, advertisements, and computer-generated letters, and “pre-sort” the mail in mail sorters. In the United States, for example, a discounted rate for first class mail may be granted if the mail meets a set of requirements for “automation mail.” The requirements include that the mail must be presented to the U.S. Post Office (USPS) in bins that are “sorted.” Each bin must contain a minimum number of envelopes in one of the following categories: (1) all envelopes will be mailed to the same 5-digit zip code; (2) all envelopes will be mailed to the same 3-digit zip code (that is, the first three digits of the zip code are the same); (3) all envelopes will be mailed to the same Automated Area Distribution Center (AADC) (which is a grouping of several zip codes determined by the USPS); or (4) all envelopes will be mailed to the same Mixed AADC (which is a grouping of AADCs designated by the USPS). Each of these categories receives a different discount. Thus, it is financially beneficial for large volume mailers to sort the mailings in such a manner as to qualify for the discounts in the most cost-effective way and with the optimal discount result. However, the financial benefits must be weighed against the time it takes to sort the mail to obtain the optimal financial discount.

### SUMMARY OF THE DISCLOSURE

The present disclosure provides a method and system for optimizing mail sorting on an envelope sorting machine by reducing the number of passes of the envelopes through the sorting machine. Reducing the number of sorting passes is beneficial for large volume mailers as each pass consumes large amounts of time and delays the sorting of the next round of mailings. The disclosure provides an exemplary method of determining optimal mail sorting of a mailing, the method comprising determining a number of mail pieces to be sent in the mailing, selecting an initial scheme for sorting the mailing based on the number of mail pieces, and simulating a mail sorting based on the initial scheme and prior mailings and obtaining efficiency statistics of the simulated mail sorting.

The initial scheme of sorting the mailing may come from various sources. For example, the initial scheme may be based on historical schemes for mailings with one or more of similar mailing types, similar number of mail pieces, or similar day of the month. The initial scheme may be selected by an operator from historical schemes for mailings. The operator may be aware of a recent mailing that is similar, and specifically select the final mailing scheme of the prior mailing as the initial scheme. As yet another example, the initial scheme may be a customized scheme for the mailing. An operator may design a scheme specifically for the mailing using the system. Once the initial scheme is selected, the mailing is simulated using prior mailings in order to predict the expected sorting results and calculate the efficiency. The mailing simulation may only take a few minutes to complete, whereas the physical mail sorting may take hours to complete.

After the selected initial scheme is simulated, the method may further comprise generating an updated scheme, in response to the efficiency statistics being less than desired, by revising the initial scheme. The method includes simulating a mail sorting based on the updated scheme, revising and simulating schemes until efficiency statistics are optimal or desired, and setting the updated scheme as an actual scheme in response to achieving optimal mailing discounts.

The present disclosure further includes computer program product of a computer readable medium usable with a programmable computer and having computer-readable code embodied therein for determining optimal mail sorting of a mailing.

### BRIEF DESCRIPTION OF THE DRAWINGS

The features and advantages of the present disclosure will become more apparent from the detailed description set forth below when taken in conjunction with the drawings.

FIG. 1 illustrates an overview of an exemplary presort mailing machine;

FIG. 2 illustrates an exemplary implementation of a presort analyzer module;

FIG. 3 illustrates an exemplary user interface view illustrating simulation results of mail sorting associated with historical schemes;

FIG. 4 illustrates an exemplary user interface through which an operator may customize a scheme or input a customized scheme;

FIG. 5 illustrates an exemplary user interface view illustrating presort module generated schemes;

FIG. 6 is a flowchart illustrating an example process for determining optimal mail sorting of a mailing; and

FIG. 7 illustrates a block diagram of an exemplary computer system.

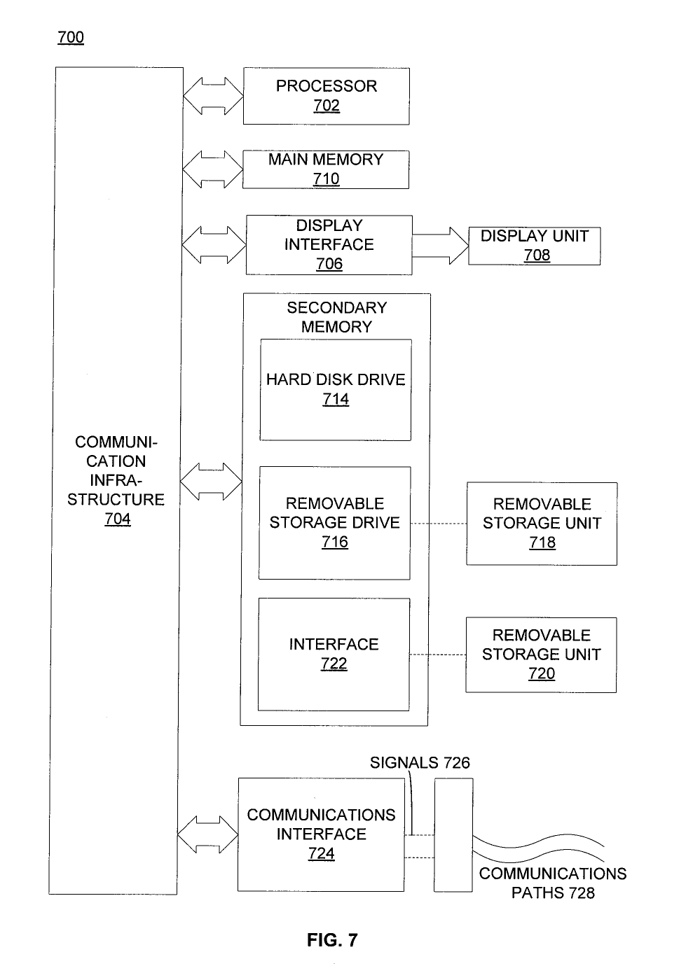

### DETAILED DESCRIPTION

The detailed description of exemplary embodiments of the present disclosure herein makes reference to the accompanying drawings and figures, which show the exemplary embodiments by way of illustration only. While these exemplary embodiments are described in sufficient detail to enable those skilled in the art to practice the various embodiments, it should be understood that other embodiments may be realized and that logical and mechanical changes may be made without departing from the spirit and scope of the present disclosure. It will be apparent to a person skilled in the pertinent art that the various embodiments may also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The present disclosure is now described in terms of an exemplary system, in which various embodiments would be implemented. It will be apparent to one skilled in the relevant art(s) that the disclosure has been described by way of illustration and not limitation, and may be implemented in alternate embodiments.

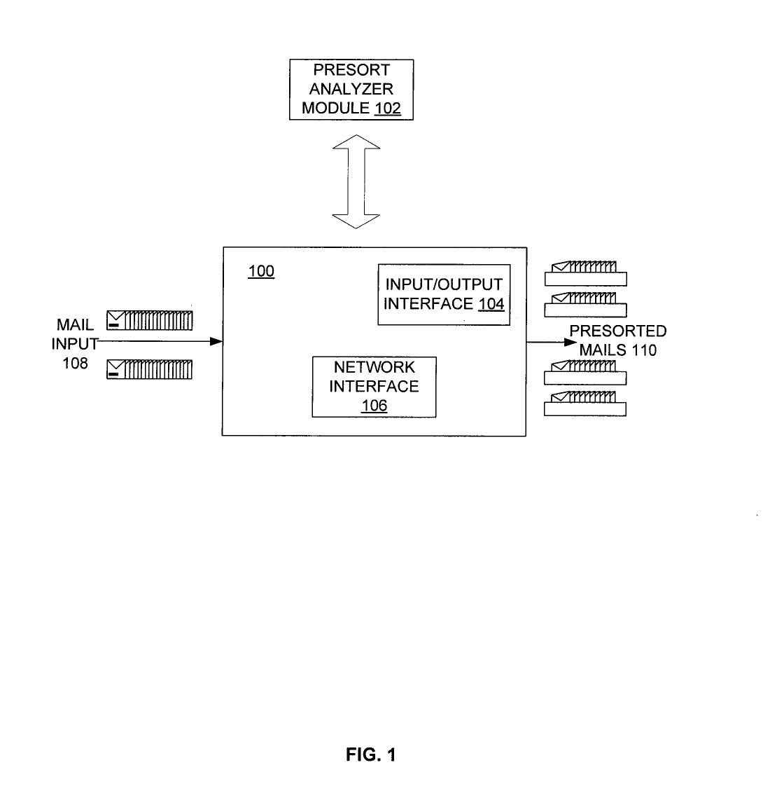

FIG. 1 is an overview of an exemplary presort mailing machine 100, in accordance with various embodiments of the present disclosure. Presort mailing machine 100 sorts mail pieces based on a scheme or a set of schemes, hereinafter, interchangeably, referred to as a mailing scheme or a mail sorting scheme. The term “mail sorting scheme” refers to a methodology or an algorithm for sorting mail pieces to obtain discount on bulk mailings, for example, according to United States Postal Service (USPS) rules. The mail sorting scheme may comprise one or more parameters. The parameters may include, a range of schema, number of mail pieces per bin, merge or split bundles of mail pieces, and the number of mail pieces retained for next day, among others. Presort mailing machine 100 is in communication with a presort analyzer module 102. Further, presort mailing machine 100 may include an input/output interface 104, and a network interface 106.

Presort analyzer module 102 controls mail sorting of presort mailing machine 100 using a mail sorting scheme or a subset of schemes. Presort analyzer module 102 simulates mail sorting for a given number of mailings using one or more candidate schemes. The one or more candidate schemes may include any of presort analyzer module 102 historical schemes, and one or more operator customized schemes, and among others. The term “candidate scheme” refers to one possible mail sorting scheme that may be analyzed by presort analyzer module 102, and may cover various types of schemes. Furthermore, the term “historical scheme” refers to a scheme that has previously been used to presort the mail in a separate, prior mailing. The term “operator selected scheme” refers to a mail sorting scheme that is selected by an operator. The term “customized scheme” refers to a mail sorting scheme that is defined by one or more sorting parameters as inputted by an operator. Other types of schemes include an “initial scheme” that refers to a mail sorting scheme to be evaluated for efficiency, and a “actual scheme” that refers to the mail sorting scheme is that implemented in the actual mail sorting. Presort analyzer module 102 calculates efficiency statistics of mail sorting associated with the one or more candidate schemes based upon the simulation. The term “efficiency statistics” may refer to estimated values corresponding to one or more efficiency parameters. Examples of the efficiency parameters may include, without limitation, cost of operation, operation time and discount obtained as a result of mail sorting, estimated number of sorting pass, efficiency in each sorting passes, number of total bins required for each pass, and so forth. Upon simulation and the calculation of efficiency statistics, presort analyzer module 102 may display results of simulation of one or more candidate schemes along with their efficiency statistics.

In one implementation, presort analyzer module 102 may set one or more of the candidate schemes associated with the mail sorting with optimal efficiency statistics as an actual scheme. In one example, efficiency statistics may be considered as optimal if an estimated cost of operation is below an operation cost threshold. In another example, efficiency statistics may be considered as optimal if the estimated operation time is below an operation time threshold. In yet another example, efficiency statistics may be considered as optimal if estimated discount is above a discount threshold. In a further example, efficiency statistics may be considered as optimal if one or more of the estimated cost of operation, the estimated operation time and the estimated discount meets the corresponding thresholds. In another example, efficiency statistics may be considered as optimal if combinations of the estimated cost of operation, the estimated operation time and the estimated discount meet their corresponding thresholds. Other variations of defining the optimal efficiency statistics are also contemplated herein.

In response to efficiency statistics of mail sorting associated with the one or more candidate schemes being less than optimal, an operator, in exemplary implementations, may generate at least one updated scheme by revising the one or more candidate schemes. In other exemplary implementations, presort analyzer module 102 may enable the operator to revise parameters for generating an updated scheme. Presort analyzer module 102 may simulate one or more prior mail sortings associated with the at least one updated scheme and determine the efficiency statistics. In response to efficiency statistics of the at least one updated scheme being less than optimal, presort analyzer module 102 may iterate the steps of generation and simulation until the mail sorting associated with the updated scheme achieves optimal efficiency statistics based on prior mailings. Upon simulating the at least one updated scheme with optimal efficiency statistics, presort analyzer module 102 may set one of the updated schemes as the actual scheme. Although it is described that a scheme having optimal efficiency statistics is set as the actual scheme, a scheme having less than optimal efficiency statistics may also be set as the actual scheme in response to the operator selection. Upon setting the actual scheme, presort mailing machine 100 may sort the mail pieces according to the actual scheme. In exemplary implementations, the presort mailing machine 100 may sort the mail pieces into, for example, 5-digit zip code bundles, 3-digit zip code bundles, area distribution center code bundles, mixed area distribution center code bundles or miscellaneous code bundles according to the actual scheme.

As described above, presort analyzer module 102 may enable the operator to test one or more initial mailing schemes by using historical data from multiple previous days. The mailing schemes may be the historical mailing schemes and/or the customized schemes. Presort analyzer module 102 may use number of mail pieces from multiple previous days as an input to the mailing schemes to simulate and predict efficiency statistics. The results of such simulations and calculation may be stored in a database. Presort analyzer module 102 may also generate one or more schemes to be used for different number of mail inputs. In one example, presort analyzer module 102 may simulate one or more schemes using statistical data comprising, for example, number of mail pieces from multiple previous days, statistics of mail sorting over a period of time (for example, one month) and the historical schemes and their corresponding efficiency statistics, among others.

Presort mailing machine 100 may include one or more components (not shown) such as, a mail inlet, a counting device, a scanning device, a sorting device, mail bins, and associated supporting hardware for sorting mail pieces. Presort mailing machine 100 may receive mail pieces (for example, mail input 108) through the mail inlet. The counting device may count the number of mail pieces processed through presort mailing machine 100. For example, a count may be made of the mail pieces as sorted into the various bins, where the mail piece count of the total bins is the total mail pieces processed. The scanning device may scan address information on the mail pieces and the store the information. In various embodiments, the address information is communicated to presort analyzer module 102. The sorting device may sort and dispose the mail pieces into appropriate mail bins, based on the actual scheme as selected by an operator. The mail bins may be outlets of presort mailing machine 100 for receiving sorted mail pieces 110. Presort mailing machine 100 may include multiple of such mail bins. Presort mailing machine 100 may designate each of the mail bins for receiving mail pieces associated with a zip code category. For example, mail bin ‘N’ may be designated to receive mail pieces having 5-digit zip code “22313”, and mail bin ‘M’ may be designated to receive mail pieces having an initial 3-digits in zip code “224”.

Presort mailing machine 100 may be communicatively coupled with external data processing systems through network interface 106. For example, presort mailing machine 100 may be communicatively coupled with presort analyzer 102. Network interface 106 may be a wired interface or a wireless interface. Presort mailing machine 100 may also be communicatively coupled with external devices and/or the data processing systems through a device interface (not shown). The device interface may be a communication port, such as, a Universal Serial Bus (USB) port, or a wireless communication component, for example, a Bluetooth interface. The external devices as described herein may include any of a printer, an external display screen, a keyboard, a pointing device, an audio device, and/or the like. The data processing systems may include a computer, a server, a database, and the like. Presort mailing machine 100 may receive input from an input console. Presort mailing machine 100 may also receive input from the external devices and/or the data processing systems. The input may include, among others, control commands (for example, operating system commands), scheme parameters, custom schemes, and the like. Presort mailing machine 100 may provide results, such as, results of simulations, reports, through the display screen, the printer, and/or audio device.

As illustrated in FIG. 1, presort analyzer module 102 is an independent data processing system in communication with presort mailing machine 100. It is appreciated that presort analyzer module 102 may also be implemented as data processing system integrated into presort mailing machine 100. Those skilled in art can appreciate that presort mailing machine 100 may include an operating system as well as various support software and drivers.

Presort analyzer module 102 may be described herein in terms of functional block components, optional selections and various processing steps. It should be appreciated that such functional blocks may be realized by any number of hardware and software components configured to perform the specified functions. For example, presort analyzer module 102 may employ various integrated circuit components, e.g., memory elements, processing elements, logic elements, look-up tables, and/or the like, which may carry out a variety of functions under the control of one or more microprocessors or other control devices. Similarly, the software elements of presort analyzer module 102 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that presort analyzer module 102 may employ any number of conventional techniques for data transmission, signaling, data processing, network control, and/or the like.

Above mentioned computer readable instructions of corresponding modules and tools may be loaded onto a general purpose computer, special purpose computer, or other programmable data processing apparatus to sort mail pieces, such that the instructions executable on the computer or other programmable data processing apparatus create means for implementing the functions specified in the flowchart block or blocks. In particular, computer readable instructions of corresponding modules and tools may be loaded into any mail sorting machines. For example, the presort analyzer module 102 may communicate be loaded in a Siemens® presorting machine, NPI® presorting machine or any other presorting machine. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

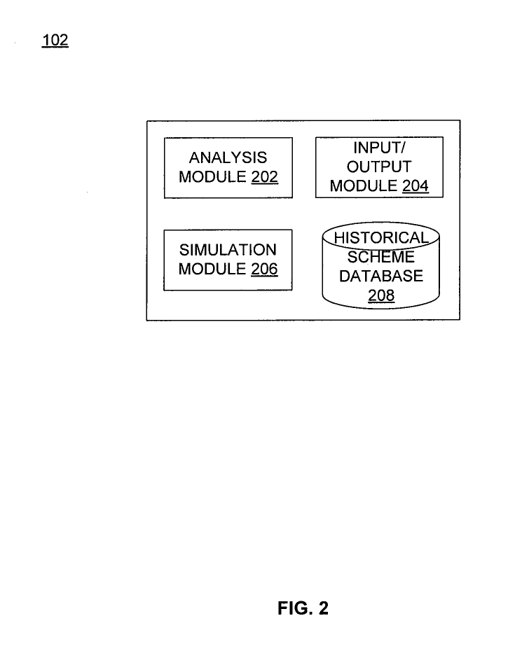

FIG. 2 illustrates an exemplary implementation of presort analyzer module 102, according to various embodiments of the present disclosure. Presort analyzer module 102 may include an analysis module 202, an input/output module 204, a simulation module 206, and a historical scheme database 208.

Analysis module 202 may receive the number of mail pieces to be sent [by individual zip code.] In various embodiments, analysis module 202 may receive, from a user, settings for the scheme such as number of schemes to be created, start and end ranges for the schemes, minimum number of mail pieces required for various discounts, and the like. In response to receiving the number of mail pieces to be sent, analysis module 202 will simulate a scheme for performing mail sorting. Analysis module 202 may also enable the operator to upload one or more schemes from historical scheme database 208 for sorting the mail pieces. A user may search and select one or more historical schemes based on the number of mail pieces. User may retrieve the one or more historical schemes may be retrieved from historical scheme database 208 or from any other external databases.

Additionally, analysis module 202 may enable the operator to input a customized scheme or parameters for generating the customized scheme for mail sorting, based on number of mail pieces to be sent. The parameters for generating the customized scheme may comprise one or more of range of schema, mail pieces per bin, merge or split bundles of mail pieces, and number of bins to be used, among others. Analysis module 202 may provide an interface such as, a graphical user interface (GUI) or a command line interface (CLI), to enable the operator to input customized scheme or the parameters for generating the customized scheme or selecting a historical scheme. In response to receiving the parameters for generating the customized scheme, analysis module 202 may create a customized scheme based on the parameters.

Selection of an actual scheme by an operator is based in part on the sorting efficiency of that specific scheme on prior mailings. An operator tests the efficiency of a scheme by simulating the sorting of prior mailings. Simulation module 206 simulates the mail sorting based on the one or more candidate schemes (for example, comprising any of analysis module 202 selected scheme, the one or more operator selected schemes and/or the operator customized scheme). In various embodiments, simulation module 206 virtually sorts the mail pieces of prior mailings into appropriate virtual bins using the mail sorting associated with each of the one or more candidate schemes. For example, assuming the current mailing is Day 10 of a random series of days, and scheme X was used for mailing sorting on Day 1, then simulation module 206 can simulate the sorting efficiency of prior mailings from Days 2-9. The efficiency results may be reviewed by a user to determine whether scheme X can be predicted to have an optimal sorting efficiency on Day 10 (current mailing). Furthermore, multiple schemes may be simulated and the user selects the scheme that is most likely to have the most efficient sorting. In other words, simulation module 206 calculates efficiency statistics of the mail sorting associated with the one or more candidate schemes. Upon simulation, simulation module 206 may provide results of the simulation including efficiency statistics through input/output module 204. Input/output module 204 may present the results in a Hyper Text Markup Language (HTML) page, a word processing document, a presentation document, a spreadsheet, or in any other form.

In response to at least one scheme of the one or more candidate schemes for mail sorting having optimal efficiency statistics, analysis module 202, in various embodiments, may set the at least one optimal scheme as an actual scheme by loading onto the sorting machine. In response to not obtaining at least one candidate scheme having optimal efficiency statistics, analysis module 202 may iterate above-mentioned steps of revision by changing the settings of the scheme and simulation of mail sorting associated with the one or more candidate schemes until efficiency statistics of mail sorting associated with at least one scheme is optimal or above a threshold. In response to simulating the one or more candidate schemes having mail sorting with optimal efficiency statistics or sufficient statistics, analysis module 202 may set one of the updated schemes as an actual scheme. Alternatively, regardless of optimal efficiency statistics, analysis module 202 may enable the operator to choose and set the actual scheme from any of the scheme choices.

In various embodiments, analysis module 202 may compare the calculated efficiency statistics of mail sorting associated with each of the one or more candidate schemes with the optimal efficiency statistics. In response to determining that at least one scheme of the one or more candidate schemes for mail sorting having optimal efficiency statistics, analysis module 202 may set one of the at least one scheme as an actual scheme. If the calculated efficiency statistics of the one or more candidate schemes are not optimal for the given number of mail pieces, analysis module 202 may revise the one or more candidate schemes. In other exemplary implementations, analysis module 202 may enable the operator to revise parameters for generating an updated scheme. The revision of the one or more candidate schemes may include, among other steps, revising the parameters of the one or more mailing scheme. The revision of parameters may include revising zip code ranges into different groupings, changing range of schemas, changing number of mail pieces per bin, merging one or more bundles of mail pieces into a single bundle, distributing a bundle of mail pieces across multiple bundles, rearranging the mail pieces of different bundles, and optimizing number of bins for mailing discounts, among others. The revision may be performed such that the one or more updated schemes show optimal efficiency statistics.

In other various embodiments, analysis module 202 may simulate one or more schemes for sorting the mail pieces independent of the historical schemes, and/or the customized schemes. Using the number of mail pieces, addresses on the mail pieces, zip code density and the like, analysis module 202 may simulate one or more schemes. Analysis module 202 may also provide an option for the operator to specify a number of mail schemes to be generated.

Additionally, analysis module 202 may enable the operator to retain small batches of mail pieces until a later day if the small mailing batches have a number of mail pieces below a threshold volume. The threshold volume may be, for example, the minimum number of mail pieces in a bundle for qualifying for a USPS bulk mailing discount. For example, if the number of mail pieces having zip code “55555” is 30 and the operator is expecting 120 or more mail pieces next day, then the operator, through analysis module 202, may retain the batch of 30 mail pieces. The operator may be enabled to combine the small batch of mail pieces with a subsequent batch of mail pieces having similar zip code to render the mail bundle eligible for a higher discount.

Historical scheme database 208 may store mail sorting related information. For example, historical scheme database 208 may store one or more historical schemes, one or more customized schemes, and statistics of mail piece sorted over a period time, among others. Historical scheme database 208 and/or one or more databases associated with presort analyzer module 102 may employ any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the system, any suitable data storage technique may be utilized to store data without a standard format. Data sets may be stored using any suitable technique, including, for example, storing individual files using an ISO/DEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, historical scheme database 208, and/or other databases store data without regard to a common format. However, in one exemplary implementation of the system, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, consumer, customer or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. Historical scheme database 208, and/or other databases described herein contemplates a data storage arrangement wherein the header or trailer, or header or trailer history, of the data is stored on the transaction instrument in relation to the appropriate data. One skilled in the art will also appreciate that, for security reasons, any databases, systems, devices, servers or other components of historical scheme database 208, and/or other databases described herein may consist of any combination thereof at a single location or at multiple locations, wherein each database or system includes any of various suitable security features, such as firewalls, access codes, encryption, decryption, compression, decompression, and/or the like.

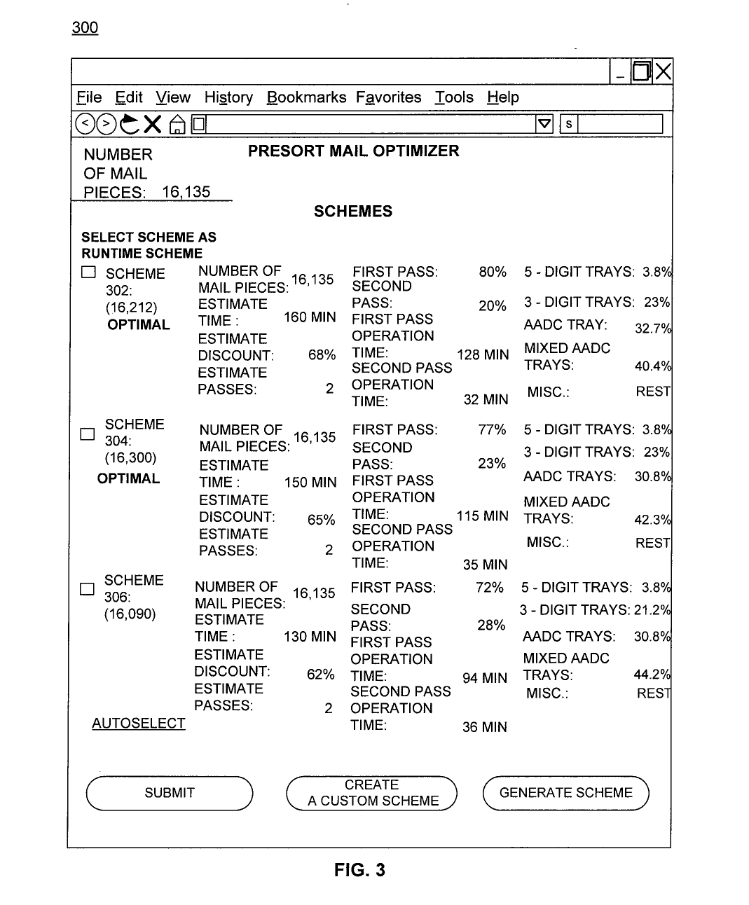

FIG. 3 is an exemplary user interface view 300 illustrating simulation results of mail sorting associated with three schemes, according to exemplary embodiments. FIG. 3 illustrates three (3) schemes (scheme 302, scheme 304 and scheme 306) selected by analysis module 202 for simulation based on the number of mail pieces to be sent. In the example as illustrated, the number of mail pieces to be sent is 16,135. The three schemes may be the historical schemes that were used for sorting approximately the same number of mail pieces. For example, scheme 302 was previously used for sorting 16,212 mail pieces, scheme 304 was previously used for sorting 16,300 mail pieces and scheme 306 was previously used for sorting 16,090 mail pieces. Each of the three schemes may have variations in parameters (not shown) for mail sorting. The historical schemes may be selected by the analysis module 202 or by the operator. Historical schemes can be saved by the user which be uploaded again to analyze. System will not store any historical schemes by itself.

An exemplary mailing scheme 302 is described now for convenience of understanding. Scheme 302 may have exemplary parameters as described below. In various embodiments, mailing may be divided among multiple sorting mediums, or into groups for multiple first passes through a sorting machine. Although generally referred to as a scheme throughout the disclosure, the mailing sorting scheme may be characterized as having multiple schemes to handle the first pass sorting of at least a portion of the mail pieces. As illustrated on the following example, a mailing may be divided at a high level based on zip code.
(a) Scheme set may be defined as including the following ranges. Namely, Scheme 1 contains zip codes 000 to 250, Scheme 2 contains zip codes 251 to 500, Scheme 3 contains zip codes 501-750, and Scheme 4 contains zip codes 751 to 999. Within the scheme set, Scheme 1 may be defined as follows: Bin 1—010; Bin 2—02123, 02124; Bin 3—043, 044; Bin 4—099; Bin 5—12039; Bin 6—123; . . . Bin 268—250; Bin 269—Second Pass; Bin 270—Rejects.
(b) Mail pieces per bin: minimum 150 per bin in case of 5-digit zip codes, minimum 150 per bin in case of 3 digit zip codes.
(c) Merge or split bundles of mail pieces: allow merging of a first bundle of mail pieces with a second bundle of mail pieces if the number of mail pieces in the first or second bundle (for example, in a bin) does not qualify for mailing discount. For example, enabling combination of mail bundle (having 50 mail pieces) in bin “K” (assigned with zip code “51232”) with mail bundle (having 100 mail pieces) in bin “P” (assigned with zip code “51234”) would lead to a bundle (having 150 mail pieces) qualifying 3-digit zip code (with initial numbers of zip codes are “512”) bundle discount. Allow splitting of a bundle of mail pieces to be distributed to other bundles of mail pieces if the number of mail pieces in at least one bin does not qualify for mailing discount. For example, enabling splitting of mail bundle (having 50 mail pieces) in bin “M” (assigned with zip code “51232”) to be distributed to with other mail bundles (having initial digits with zip code “512”) would enhance mail piece discounts for mail pieces as a bundle of 50 mails may be distributed into bins that have qualified for bulk mail discounts.

Further, FIG. 3 illustrates simulation results and efficiency statistics obtained from simulation of mail sorting for the given mail pieces using each of the schemes. As shown in FIG. 3, scheme 302 may take an estimated 160 minutes to perform mail sorting for 16,135 mail pieces. Scheme 302 may generate an estimated discount of about 68% and takes two (2) sorting passes to achieve optimal sorting. Scheme 302 may sort 80% of mail pieces in first pass in an estimated time of 128 minutes. Scheme 302 may sort 20% of remaining mail pieces in second pass in an estimated time of 45 minutes). Scheme 302 may generate 10 bundles of mail pieces associated with 5-digit zip code category, 60 bundles of mail pieces associated with 3-digit zip code category, 85 bundles of mail pieces associated with AADC category and 105 bundles of mail pieces associated the MAADC category. Each of these bundles is stacked in corresponding assigned bins. Remaining mail pieces which do not belong to the abovementioned categories may be placed in bins configured for receiving miscellaneous mail pieces to be sorted as part of the second pass.

Similarly, scheme 304 may take an estimated 150 minutes to perform mail sorting for 16,135 mail pieces. Scheme 304 may generate an estimated discount of about 65% and takes two (2) sorting passes to complete the sorting process. Scheme 304 may sort 77% of mail pieces in first pass in an estimated time of 115 minutes. Scheme 304 may sort 23% of remaining mail pieces in second pass in an estimated time of 35 minutes). Scheme 304 may generate 10 bundles of mail pieces associated with 5-digit zip code category, 60 bundles of mail pieces associated with 3-digit zip code category, 80 bundles of mail pieces associated with AADC category and 105 bundles of mail pieces associated the MAADC category to be sorted as part of the second pass.

Similarly, scheme 306 may take an estimated 130 minutes to perform mail sorting for 16,135 mail pieces. Scheme 306 may generate an estimated discount of about 62% and takes two (2) sorting passes to complete the sorting process. Scheme 306 may sort 72% of mail pieces in first pass in an estimated time of 94 minutes. Scheme 306 may sort 28% of remaining mail pieces in second pass in an estimated time of 36 minutes). Scheme 306 may generate 10 bundles of mail pieces associated with 5-digit zip code category, 55 bundles of mail pieces associated with 3-digit zip code category, 80 bundles of mail pieces associated with AADC category and 115 bundles of mail pieces associated the MAADC category. Remaining mail pieces which do not belong to the abovementioned categories may be placed in bins configured for receiving miscellaneous mail pieces to be sorted as part of the second pass.

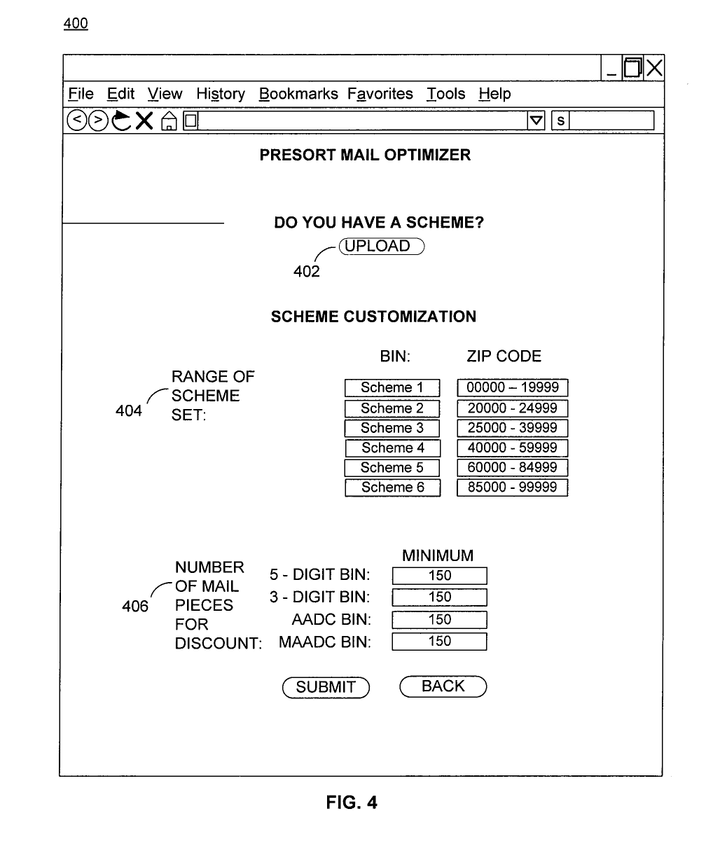

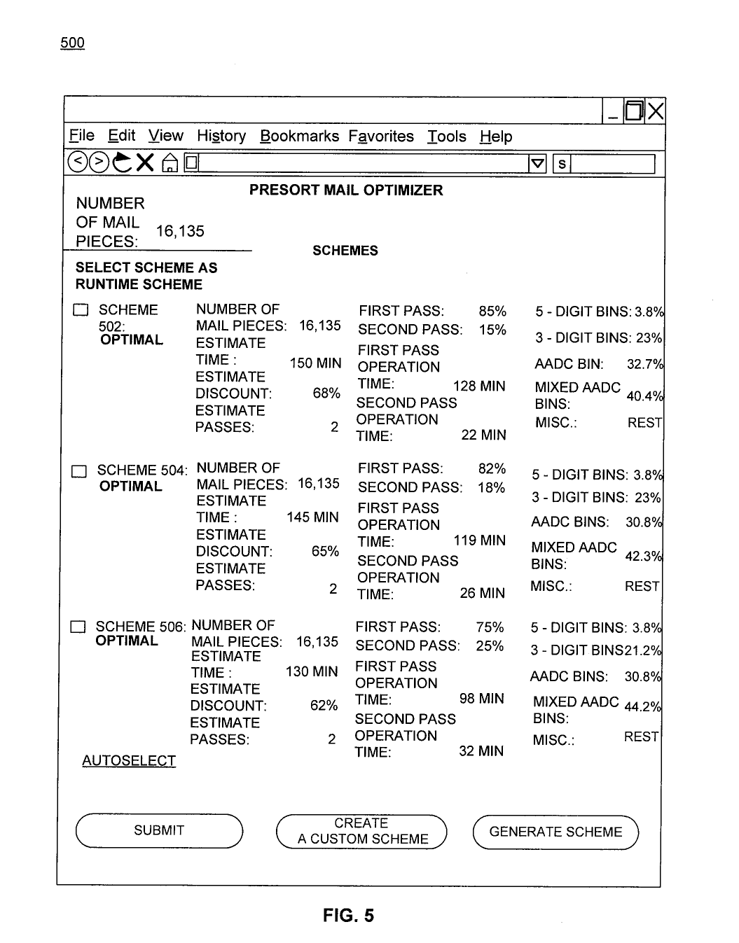

An indication may be provided, as illustrated in user interface 300, if one or more mailing schemes have optimal efficiency statistics. In various embodiments, regardless of efficiency statistics of mail sorting associated with schemes 302, 304, 306 being optimal or non-optimal, the user interface 300 may allow the operator to choose one of schemes 302, 304, 306 as an actual scheme. User interface 300 also provides options to the operator such as an option to create a custom scheme based on input parameters. In response to selection of custom scheme option, presort analyzer module 102 may provide a user interface as illustrated in FIG. 4. In response to the operator selection of generate scheme option, presort analyzer module 102 may provide a user interface as illustrated in FIG. 5.

FIG. 4 illustrates an exemplary user interface 400 through which the operator may customize a scheme or input a customized scheme. The customized scheme may be uploaded into a presort mailing machine, such as presort mailing machine 100. The customized scheme may be uploaded directly or through a data processing system coupled to presort mailing machine 100. User interface 400 may provide an option, such as an upload button 402, which when clicked, may initiate another interface (not shown). The other interface may be a popup interface to specify a path of a scheme file or to select the scheme file directly using a pointing device and/or to drag and drop the scheme file into the interface. In various embodiments, the scheme file may be an extended markup file (XML) file, a spreadsheet file, a comma separated file (CSV) file, a text file and the like. In response to a selection of the scheme file, the other user interface may upload the scheme file to generate a customized scheme.

User interface 400 may also provide options for scheme customization. FIG. 4 illustrates two such parameters (for example, range of schema 404 and the number of mail pieces per bin 406). Range of schema 404 option enables the operator to input bin ranges and zip codes to be associated with the input bin or bin ranges. FIG. 4 illustrates range of schema 404 option on a coarse level. For example, zip codes 10000-19999 are assigned to bins 1-50. Similarly, 20000-24999 are assigned to bins 50-100 and so on. A fine range option is also provided in user interface 400 which when clicked enables the operator to input bin ranges and zip codes to be associated with the input bin ranges on a finer level. For example, the operator may be enabled to assign 10000-12000 zip codes to bins 1-10 and 12001-14000 to bins 11-20 and so on. The number of mail pieces/bin 406 option enables the operator to define minimum number and/or maximum number of mail pieces to be stacked in each bin. FIG. 4 illustrates 150 mail pieces as a minimum number of mail pieces to be stacked in bins assigned to each of 5-digit zip code, 3-digit zip code, the AADC zip code and the MAADC bin zip code. User interface 400 also provides submit option to submit the custom parameters to generate a customized scheme.

In various embodiments and with reference to FIG. 5, a graphical user interface 500 illustrating analysis module 202 generated schemes is presented. Analysis module 202 may generate schemes independently or upon the operator command. In one embodiment, the schemes are generated based on the operator command. For example, a user click on the generate scheme option. FIG. 5 illustrates three (3) generated schemes (scheme 502, scheme 504 and scheme 506) with their efficiency statistics.

As illustrated in FIG. 5, scheme 502 may take an estimate 150 minutes to perform mail sorting for 16,135 mail pieces. Scheme 502 may generate an estimated discount of about 68% and takes two (2) sorting passes to complete the sorting process. Scheme 502 may sort 70% of mail pieces in first pass in an estimated time of 105 minutes. Scheme 502 may sort 30% of remaining mail pieces in second pass in an estimated time of 45 minutes). Scheme 502 may generate an estimated 3.8% of bundles of mail pieces associated with 5-digit zip code category, 23% of bundles of mail pieces associated with 3-digit zip code category, 32.7% of bundles of mail pieces associated with the AADC category and 40.4% of bundles of mail pieces associated the MAADC category. Each of these bundles may be stacked in their corresponding assigned bins. Remaining mail pieces which do not belong to the abovementioned categories may be placed in bins configured for receiving miscellaneous mail pieces.

Similarly, scheme 504 may take an estimated 145 minutes to perform mail sorting for 16,135 mail pieces. Scheme 504 may generate an estimated discount of about 65% and takes two (2) sorting passes to complete the sorting process. Scheme 504 may sort 68% of mail pieces in first pass in an estimated time of 97 minutes. Scheme 504 may sort 32% of remaining mail pieces in second pass in an estimated time of 46 minutes). Scheme 504 may generate 3.8% bundles of mail pieces associated with 5-digit zip code category, 23% of bundles of mail pieces associated with 3-digit zip code category, 30.8% of bundles of mail pieces associated with the A ADC category and 42.3% of bundles of mail pieces associated the MAADC category.

Similarly, scheme 506 may take 130 minutes to perform mail sorting for 16,135 mail pieces. Scheme 506 may generate an estimated discount of about 62% and takes two (2) sorting passes to complete the sorting process. Scheme 506 may sort 72% of mail pieces in first pass in an estimated time of 94 minutes. Scheme 506 may sort 28% of remaining mail pieces in second pass in an estimated time of 36 minutes). Scheme 506 may generate 3.8% of bundles of mail pieces associated with 5-digit zip code category, 21.2% of bundles of mail pieces associated with 3-digit zip code category, 30.8% of bundles of mail pieces associated with the AADC category and 44.2% of bundles of mail pieces associated the MAADC category. Remaining mail pieces which do not belong to the abovementioned categories may be placed in bins configured for receiving miscellaneous mail pieces. User interface 500 may also provide an option for the operator to allow automatic selection of a scheme among schemes 502, 504, 506 as an actual scheme.

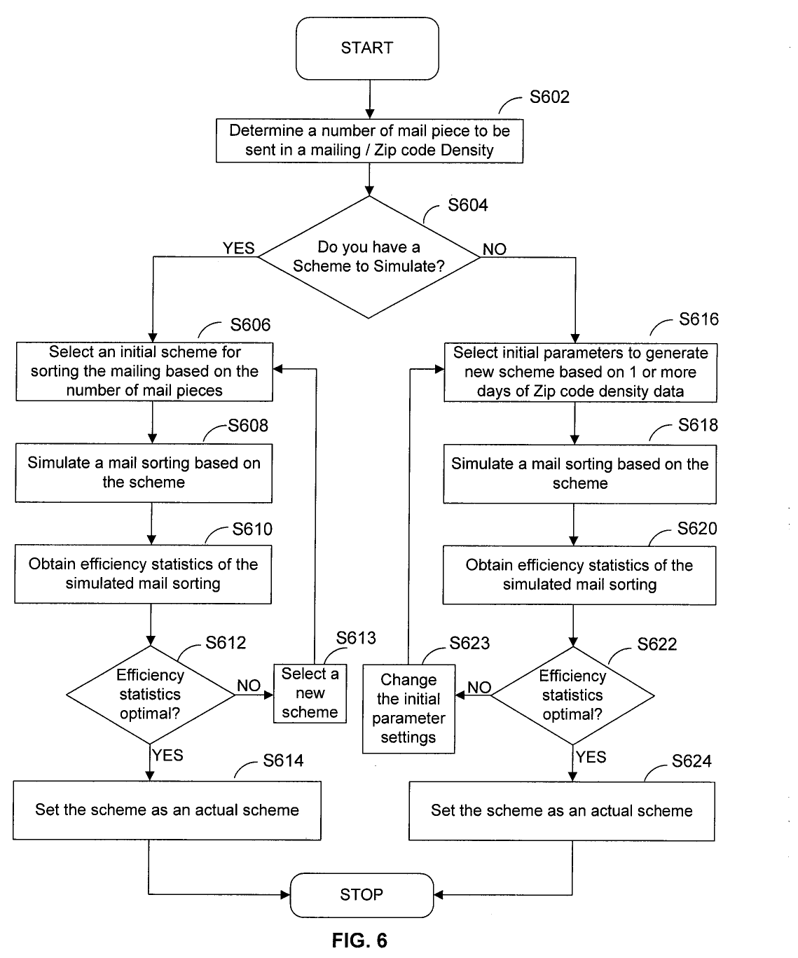

FIG. 6 is a flowchart illustrating one exemplary process for determining optimal mail sorting of a mailing, in accordance with various embodiments. In step S602, presort analyzer module 102 may determine a number of mail pieces to be sent in a mailing and corresponding zip code density, or number of mail pieces in a day and corresponding zip code density. Further, in step S604, presort analyzer module 102 may select and/or query a user for a scheme to simulate. If there is a scheme to simulate, at step S606, presort analyzer module 102 may select an initial scheme for sorting the mailing based on the number of mail pieces. Presort analyzer module 102 may further, at step S608, simulate a mail sorting based on the selected scheme. At step S610, efficiency statistics of the simulated mail sorting are obtained. If the obtained efficiency statistics are optimal or substantially optimal, at step S612, presort analyzer module 102 may, at step S614, set the selected scheme as an actual scheme. If the obtained efficiency statistics are not optimal or are not substantially optimal, presort analyzer module 102 may, at step S613, select a new scheme and return to step S606.

Continuing, and if, on the other hand, there is not a scheme to simulate at step S604, presort analyzer module 102 may, at step S616, select one or more initial parameters to generate one or more new schemes based on one or more days of zip code density data. Having selected initial parameters, presort analyzer module 102 may simulate a mail sorting based on the one or more new schemes at step S618, and, at step S620, presort analyzer module 102 may obtain efficiency statistics of the simulated mail sorting. If, at step S622, the efficiency statistics of the simulated mail sorting are optimal or substantially optimal, presort analyzer may, at step S624, set the scheme as an actual scheme. If, however, at step S622, the efficiency statistics of the simulated mail sorting are not optimal or are not substantially optimal, at step S623, presort analyzer 102 may change the initial parameter settings and return to step S616.

The present disclosure (i.e., presort mailing machine 100, presort analyzer module 102, any part(s) or function(s) thereof) may be implemented using hardware, software or a combination thereof, and may be implemented in one or more computer systems or other processing systems. However, the manipulations performed by the various embodiments were often referred to in terms, such as comparing or checking, which are commonly associated with mental operations performed by a human operator. No such capability of a human operator is necessary, or desirable in most cases, in any of the operations described herein, which form a part of the various embodiments. Rather, the operations are machine operations. Useful machines for performing the operations in the present disclosure may include general-purpose digital computers or similar devices.

In fact, various embodiments may be directed towards one or more computer systems capable of carrying out the functionality described herein.

Computer system 700 includes at least one processor, such as a processor 702. Processor 702 is connected to a communication infrastructure 704, for example, a communications bus, a cross over bar, a network, and the like. Various software embodiments are described in terms of this exemplary computer system 700. After reading this description, it will become apparent to a person skilled in the relevant art(s) how to implement the present disclosure using other computer systems and/or architectures.

Computer system 700 includes a display interface 706 that forwards graphics, text, and other data from the communication infrastructure 704 for display on a display unit 708.

Computer system 700 further includes a main memory 710, such as random access memory (RAM), and may also include a secondary memory 712. The secondary memory 712 may further include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a well known manner. The removable storage unit 718 may represent a floppy disk, magnetic tape or an optical disk, and may be read by and written to by the removable storage drive 716. As will be appreciated, the removable storage unit 718 includes a computer usable storage medium having stored therein, computer software and/or data.

In accordance with various embodiments of the present disclosure, the secondary memory 712 may include other similar devices for allowing computer programs or other instructions to be loaded into the computer system 700. Such devices may include, for example, a removable storage unit 720, and an interface 722. Examples of such may include a program cartridge and cartridge interface (such as that found in video game devices), a removable memory chip (such as an erasable programmable read only memory (EPROM), or programmable read only memory (PROM)) and associated socket, and other removable storage unit 720 and interfaces 722, which allow software and data to be transferred from the removable storage unit 720 to the computer system 700.

Computer system 700 may further include a communication interface 724. The communication interface 724 allows software and data to be transferred between computer system 700 and external devices. Examples of the communication interface 724 include, but may not be limited to a modem, a network interface (such as an Ethernet card), a communications port, a Personal Computer Memory Card International Association (PCMCIA) slot and card, and the like. Software and data transferred via the communication interface 724 are in the form of a plurality of signals, hereinafter referred to as signals 726, which may be electronic, electromagnetic, optical or other signals capable of being received by the communication interface 724. Signals 726 are provided to the communication interface 724 via a communication path (e.g., channel) 728. The communication path 728 carries the signals 726 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 716, a hard disk installed in hard disk drive 714, signals 726, and the like. These computer program products provide software to the computer system 700. The present disclosure is directed to such computer program products.

Computer programs (also referred to as computer control logic) are stored in the main memory 710 and/or the secondary memory 712. Computer programs may also be received via the communication infrastructure 704. Such computer programs, when executed, enable computer system 700 to perform the features of the various embodiments, as discussed herein. In particular, the computer programs, when executed, enable the processor 702 to perform the features of the various embodiments. Accordingly, such computer programs represent controllers of the computer system 700.

In accordance with various embodiments, where the embodiments are implemented using a software, the software may be stored in a computer program product and loaded into computer system 700 using the removable storage drive 716, the hard disk drive 714 or the communication interface 724. The control logic (software), when executed by the processor 702, causes the processor 702 to perform the functions of the various embodiments as described herein.

Other various embodiments are implemented primarily in hardware using, for example, hardware components such as application specific integrated circuits (ASIC). Implementation of the hardware state machine so as to perform the functions described herein will be apparent to persons skilled in the relevant art(s). In yet another embodiment, implementation may use a combination of both the hardware and the software.

While various embodiments of the disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture described of the present disclosure is sufficiently flexible and configurable, such that it may be utilized (and navigated) in ways other than that shown in the accompanying figures.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments of the disclosure, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method comprising;
determining, by a computer-based system configured for determining optimal mail sorting of a mailing, a number of mail pieces to be sent in the mailing;
selecting, by the computer-based system, an initial scheme for sorting the mailing based on the number of mail pieces;
simulating, by the computer-based system, a mail sorting based on the initial scheme and prior mailings;
obtaining, by the computer-based system, efficiency statistics of the simulated mail sorting on the prior mailings;
generating, by the computer-baaed system and in response to obtaining sub-optimal efficiency statistics, an updated scheme by revising the initial scheme;
simulating, by the computer-based system, the mail sorting based on the updated scheme;
revising and simulating, by the computer-based system, schemes until efficiency statistics are optimal; and
setting, by the computer-based system, the updated scheme as an actual scheme, in response to achieving, optimal mailing discounts.

2. The method of claim 1, wherein the initial scheme is based on historical schemes for mailings of about the same number of mail pieces.

3. The method of claim 1, wherein the initial scheme is selected by an operator from historical schemes for mailings.

4. The method of claim 1, wherein the initial scheme is a customized scheme for the mailing.

5. (canceled)

6. The method of claim 1, wherein the generating the updated scheme comprises revising zip code ranges into different groupings.

7. The method of claim 1, wherein the generating the updated scheme comprises revising configurable parameters such as range of schema and mail pieces per bin.

8. The method of claim 1, wherein the optimal mailing discounts comprises optimizing the number of bins for the mailing discounts.

9. The method of claim 1, wherein the generating the updated scheme comprises merging one or more of bundles of mailings into at least one merged mailing.

10. The method of claim 9, wherein the one or more of the bundles of mailings is evaluated in regards to postage cost to determine an optimal combination of bundles of mailings.

11. The method of claim 10, wherein the combination of bundles of mailings is combined based on one of a 5-digit zip code, a 3-digit zip code, area distribution center code, or mixed area distribution center code.

12. The method of claim 1, wherein the actual scheme works on both Siemens and NPI presort equipment.

13. The method of claim 1, further comprising testing mailing schemes by simulating using historical data from multiple previous days.

14. The method of claim 1, further comprising retaining small mailing batches until a later day if the small mailing batches have a number of mailings below a threshold volume.

15. A presort mailing machine comprising:
a processor configured for determining optimal mail sorting of a mailing,
a tangible, non-transitory memory configured to communicate with the processor,
the tangible, non-transitory memory having instructions stored thereon that, in response to execution by the processor, cause the processor to perform operations comprising: determining, by the processor, a number of mail pieces to be sent in the mailing; selecting, by the processor, an initial scheme for sorting the mailing based on the number of mail pieces; and
simulating, by the processor, a mail sorting based on the initial scheme and prior mailings, and obtaining efficiency statistics of the simulated mail sorting on the prior mailings;
generating, by the processor and in response to obtaining sub-optimal efficiency statistics, an updated scheme by revising the initial scheme;
simulating, by the processor, the mail sorting based on the updated scheme;
revising and simulating, by the computer-based system, schemes until efficiency statistics are optimal; and
setting, by the processor, the updated schema as an actual scheme in response to achieving optimal mailing discounts.

16. (canceled)

17. The presort mailing machine of claim 15, wherein the generating the updated scheme comprises revising zip code ranges into different groupings.

18. The presort mailing machine of claim 15, wherein the generating the updated scheme comprises revising configurable key parameters such as range of schema and mail pieces per bin.

19. A non-transitory, tangible computer-readable storage medium having computer-executable instructions stored thereon that, if executed by a computer based system for determining optimal mail sorting of a mailing, cause the computer based system to perform operations comprising:
determining, by the computer-based system, a number of mail pieces to be sent in the mailing;
selecting, by the computer-based system, an initial scheme for sorting the mailing based on the number of mail pieces; and
simulating, by the computer-based system, a mail sorting based on the initial scheme and prior mailings, and obtaining efficiency statistics of the simulated mail sorting on the prior mailings;
generating, by the computer-based system and in response to obtaining sub-optimal efficiency statistics, an updated scheme by revising the initial scheme;
simulating, by the computer-based system, the mail sorting based on the updated scheme;
revising and simulating, by the computer-based system, schemes until efficiency statistics are optimal; and
setting, by the computer-based system, the updated scheme as an actual scheme in response to achieving optimal mailing discounts.

20. (canceled)
